(19) United States
(12) Patent Application Publication
(10) Pub. No.: US 2005/0288971 A1
(43) Pub. Date: Dec. 29, 2005

(54) Critical illness insurance product and system for administering same

(76) Inventor: Frank Cassandra, Bridgewater, NJ (US)

Correspondence Address: MORGAN LEWIS & BOCKIUS LLP, 1111 PENNSYLVANIA AVENUE NW, WASHINGTON, DC, 20004, US

(21) Appl. No.: 11/151,815

(22) Filed: Jun. 13, 2005

Related U.S. Application Data
(60) Provisional application No. 60/578,996, filed on Jun. 11, 2004.

(51) Int. Cl. G06Q 40/00

(52) U.S. Cl. 705/4

(57) ABSTRACT

The present systems and methods enable an insurance underwriter to offer group term specified disease coverage. Such policies can provide lump-sum benefits for occurrences of conditions that are covered under the policy. In particular, coverages can be provided for specified diseases such as: (1) various forms of cancer; (2) heart attack; (3) coronary artery bypass graft; (4) kidney failure; (5) major organ transplant; (6) stroke; and (7) skin cancer. As will be recognized, different types of cancer may also result in varying levels of coverage. For example, there may be benefit differences for cancers termed “full coverage cancers,” those termed “partial benefits cancers,” and those generally called “other cancer.”.

### CROSS-REFERENCE TO RELATED APPLICATIONS

This application claims the benefit of U.S. Provisional Application No. 60/578,996, filed Jun. 11, 2004. The entire contents of the above application are incorporated herein by reference.

### SUMMARY

The present systems and methods enable an insurance underwriter to offer group term specified disease coverage. Such policies can provide lump-sum benefits for occurrences of conditions that are covered under the policy. In particular, coverages can be provided for specified diseases such as: (1) various forms of cancer; (2) heart attack; (3) coronary artery bypass graft; (4) kidney failure; (5) major organ transplant; (6) stroke; and (7) skin cancer. As will be recognized, different types of cancer may also result in varying levels of coverage. For example, there may be benefit differences for cancers termed “full coverage cancers,” those termed “partial benefits cancers,” and those generally called “other cancer.”

In one embodiment, a member of a group pays a premium for coverage of one or more specified diseases. Such premiums can reflect coverage for all diseases coverable under the policy, or may only reflect coverage for one or more diseases from the full list of diseases coverable under the policy. As will be recognized by those skilled in the art, the group policy may have premiums paid by the group policyholder, by the individual members, or by a combination of the two.

As illustrated below, in certain embodiments, different members will have their premiums calculated in different ways. Such premiums may have adjustments based on the covered member's relationship to the entity providing the group policy. Additionally, policy premiums may be at a standard rate for both employees as well as dependents of the employees covered under the policy.

In one embodiment, a computer system is operable to maintain a database of policy related data. Such data can include the premium amounts, policy amounts, coverage amounts, policy terms, parties to the policy, group entity, and other group insurance related terms. The database may contain a single entry for all data, or related entries comprising all information for a particular member, policy, group or other policy related member. For example, one database entry may contain the name, regarding the policy amount, premium amount, coverage amount, and other policy related information.

The computer system may further be operable to calculate premium amounts, determine benefit payouts, send and receive notifications regarding the policy, and provide an interface for policyholders, members, or the insurance provider to maintain, update, edit, review, or otherwise access information about the policy. For example, the policyholder may be provided a mechanism to add new employees to the group policy; the member may be able to add a new dependent; and the provider may be able to add a new coverage, or modify the payout amount for a particular condition.

### FIGURES

FIG. 1 is a flow diagram illustrating one embodiment of the present systems and methods.

### DETAILED DESCRIPTION

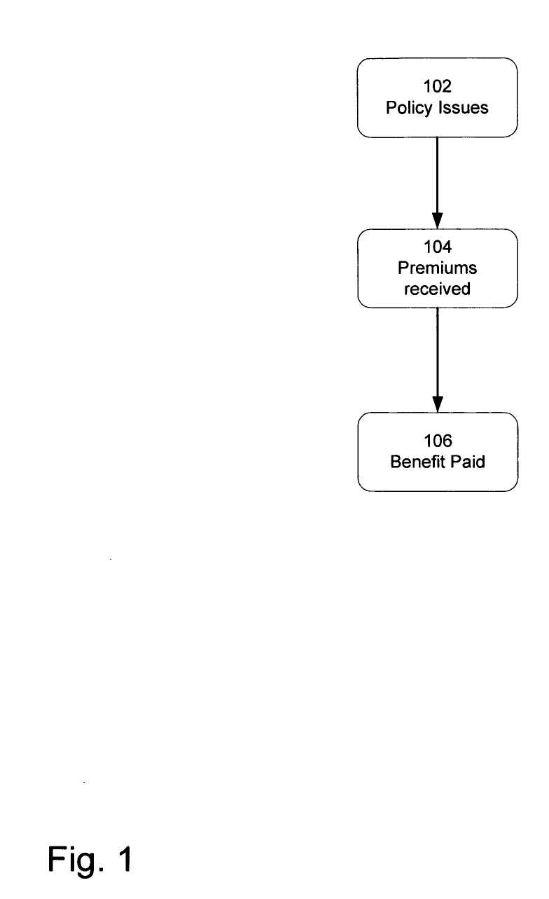

As shown in FIG. 1, in step 102, an underwrite or policy provider issues a group term specified disease policy. Terms of such policies are described below. The policy can be issued to an employee of the group holding the policy, and may cover the employee as well as the spouse and dependents of the employee. In step 104, premiums are received for the policy. As will be recognized, such premiums may come from the employee, the group policyholder, or a combination of both. In step 106, a benefit is paid to a person covered under the policy based on meeting criteria specified in the terms of the policy. As will be recognized, the premiums and benefits may be calculated for each group, and may also be modified based on new criteria as appropriate.

In one embodiment, a group specified disease coverage policy provides the following terms and descriptions.

### Section XXXVI

### Group Specified Disease Coverage

I. The group policy provides a lump-sum benefit for the first occurrence of a covered condition in a covered person's lifetime either in accordance with a specified schedule of insurance, or in amounts which are optional to the employee. Benefits amounts will be offered for sale in even increments of $1,000. In no event shall coverage on any single individual exceed $500,000. For certain clearly identifiable forms of diseases with significantly lower treatment costs, lesser amounts may be offered, but in no event shall any such amount be lower than $250. Coverage may be offered on a non-contributory basis with premiums paid by the group policyholder or on a contributory basis with premiums paid by group certificate holders.
Coverage may also be provided for dependent spouses and dependent children of employees.

II. Policies Providing Benefits According to a Specified Schedule of Insurance with Premiums to be Paid by the Group Policyholder

A. Specified Schedule of Insurance

| COVERED | |
|---|---|
| CONDITION | STANDARD OFFERING BENEFIT |
| Full Benefit Cancer | 100% of Total Benefit Amount |
| Partial Benefit Cancer | Lesser of {$15,000, 25% of Total |
| | Benefit Amount} |
| Heart Attack | 100% of Total Benefit Amount |
| Coronary Artery Bypass Graft | Lesser of {$15,000, 25% of Total |
| | Benefit Amount} |
| Kidney Failure | 100% of Total Benefit Amount |
| Major Organ Transplant | 100% of Total Benefit Amount |
| Stroke | 100% of Total Benefit Amount |
| Skin Cancer | $250 |
| Other Cancer | $1,000 |

The Total Benefit Amount means the maximum amount payable under the policy per covered person for all Covered Conditions combined as specified in the Schedule of Insurance.

B. Standard Monthly Premium Rates for Specified Schedule of Insurance on Employees

The standard monthly premium rates per $1,000 of coverage for each group applicable to policyholder paid employee coverage will be computed based on the demographics of the group and the principal industry of employment of that group according to the following algorithm.

Step 1A: Cross multiply the base monthly premium rates shown in Table XXXVI.IA with the applicable proposed coverage amounts (in thousands) determined using a complete census of the insured classes of employees or eligible classes of employees provided by the group policyholder. Sum the result obtained for each age and gender cell across all age and gender cells.

Step 1B: Cross multiply the base monthly premium rates shown in Table XXXVI.IB with the applicable proposed coverage amounts (in thousands) for skin cancer coverage (0.250 for the standard offering benefit) determined using a complete census of the insured classes of employees or eligible classes of employees provided by the group policyholder. Sum the result obtained for each age and gender cell across all age and gender cells.

Step 2: Sum the results of Step 1A and Step 1B.

Step 3: Sum the total proposed coverage amounts across the entire census used in Step 1A.

Step 4: Divide the result of Step 2 by the result of Step 3.

Step 5: Multiply the result of Step 4 by the applicable Industry Adjustment Factor from Table XXXVI.2.

Step 6: Multiply the result of Step 5 by the appropriate Volume Adjustment Factor from Table XXXVI.3.

Step 7: Adjust the results from Step 6 to reflect an increasing trend in claim cost. The baseline rates derived from Step 6 will be multiplied by 1.xxxˆT, where T is the elapsed time (measured in years) from Jul. 1, 2005 to the mid-point of the prospective policy period.

Step 8: Broker commissions payable in accordance with Section XXX of this manual will be included in the final premium rates if applicable.

Step 9: Round the results of Step 8 to 3 decimal places to determine the final result.

C. Adjustments to Standard Monthly Premium Rates for Specified Schedule of Insurance on Employees

1. If any of the Covered Conditions outlined in Section II.A are to be included with a different benefit percentage, the premium rate determined in Step 1A should be multiplied by a factor (f_{Bj}) for each age j, before proceeding to Step 2, where f_{Bj} is defined as
   f_{Bj}=1−Σᵢ((1−Bᵢ)*Cⱼᵢ), i=1,6
   where
   j is the index for age (17≦j≦100),
   Bᵢ is the ratio of the new benefit percentage to the standard benefit percentage for Covered Condition i, and
   Cⱼᵢ is the age-dependent weight of Covered Condition i, as outlined in Table XXXV1.4, Part A.
      D. Standard Monthly Premium Rates for Specified Schedule of Insurance on Dependent Spouses

The standard monthly premium rates per $1,000 of coverage for each group applicable to policyholder paid, dependent spouse coverage will be computed based on the demographics of the group and the principal industry of employment of that group according to the following algorithm.

Step 1A: Cross multiply the base monthly premium rates shown in Table XXXVI.1A with the applicable proposed coverage amounts (in thousands) determined using a complete census of the insured classes of dependent spouses or eligible classes of dependent spouses provided by the group policyholder. Sum the result obtained for each age and gender cell across all age and gender cells. In the event a dependent spouse census is not available, an employee census may be used assuming spouses are of the opposite sex of the employee and employing a suitable age differential between employees and spouses.

Step 1B: Cross multiply the base monthly premium rates shown in Table XXXVI.IB with the applicable proposed coverage amounts (in thousands) for skin cancer coverage (0.250 for the standard offering benefit) determined using a complete census of the insured classes of dependent spouses or eligible classes of dependent spouses provided by the group policyholder. Sum the result obtained for each age and gender cell across all age and gender cells. In the event a dependent spouse census is not available, an employee census may be used assuming spouses are of the opposite sex of the employee and employing a suitable age differential between employees and spouses.

Step 2: Sum the results of Step 1A and Step 1B.

Step 3: Sum the total proposed coverage amounts across the entire census used in Step 1A.

Step 4: Divide the result of Step 2 by the result of Step 3.

Step 5: Multiply the result of Step 4 by the applicable Industry Adjustment Factor from Table XXXVI.2.

Step 6: Multiply the result of Step 5 by the appropriate Volume Adjustment Factor from Table XXXVI.3.

Step 7: Adjust the results from Step 6 to reflect an increasing trend in claim cost. The baseline rates derived from Step 6 will be multiplied by 1.xxxˆT, where T is the elapsed time (measured in years) from Jul. 1, 2005 to the mid-point of the prospective policy period.

Step 8: Broker commissions payable in accordance with Section XXX of this manual will be included in the final premium rates if applicable.

Step 9: Round the results of Step 8 to 3 decimal places to determine the final result.

E. Adjustments to Standard Monthly Premium Rates for Specified Schedule of Insurance on Dependent Spouses

1. If any of the Covered Conditions outlined in Section II.A are to be included with a different benefit percentage, the premium rate determined in Step 1A should be multiplied by a factor (f_{Bj}) for each age j, before proceeding to Step 2, where f_{Bj} is defined as
   f_{Bj}=1−Σᵢ((1−Bᵢ)*Cⱼᵢ), i=1,6
   where
   j is the index for age (17≦j≦100),
   Bᵢ is the ratio of the new benefit percentage to the standard benefit percentage for Covered Condition i, and
   Cⱼᵢ is the age-dependent weight of Covered Condition i, as outlined in Table XXXVI.4, Part B.

F. Standard Monthly Premium Rates for Specified Schedule of Insurance on Dependent Children

If the policy provides standard benefits for dependent children, the standard monthly premium rates per $1,000 will be based on the age at which dependent child coverage ends as contained in the policy as shown in the following table:

| Dependent Child Definition | Monthly Premium Rate per $1,000 |
|---|---|
| To age 18 | |
| To age 19* | |
| To age 20* | |
| To age 21* | |
| To age 22* | |
| To age 23* | |
| To age 24* | |
| To age 25* | |
| To age 26* | |

*provided the child is a full time student

III. Policies Providing Voluntary Amounts with Premiums to be Paid by the Participants of the Group Policy

A. Standard Schedule of Voluntary Insurance

| COVERED | |
|---|---|
| CONDITION | STANDARD OFFERING BENEFIT |
| Full Benefit Cancer | 100% of Total Benefit Amount |
| Partial Benefit Cancer | Lesser of {$15,000, 25% of Total |
| | Benefit Amount} |
| Heart Attack | 100% of Total Benefit Amount |
| Coronary Artery Bypass Graft | Lesser of {$15,000, 25% of Total |
| | Benefit Amount} |
| Kidney Failure | 100% of Total Benefit Amount |
| Major Organ Transplant | 100% of Total Benefit Amount |
| Stroke | 100% of Total Benefit Amount |
| Skin Cancer | $250 |
| Other Cancer | $1,000 |

The Total Benefit Amount means the maximum amount payable under the policy per covered person for all Covered Conditions combined as selected by the covered person and as specified in the certificate.

B. Monthly Premium Rates for Standard Schedule of Voluntary Insurance for Employee Coverage

Uni-sex rates per $1,000 of voluntary coverage will be developed by smoking status in 5-year age brackets for each group policy. The premiums charged to covered persons will be based on the actual amount of coverage elected by the covered person, the covered person's attained age, and the covered person's smoking status. A schedule of uni-smoker rates will also be available.

A premium schedule of monthly unisex rates per $1,000 of coverage for each group applicable to voluntary employee coverage will be computed based on the demographics of the group and the principal industry of employment of that group according to the following algorithm.

Step 1: Determine the expected distribution of employee coverage between male and female employees. If a group specific employee census is available, the percentage of males and females within the overall group should be determined directly from the data. If no census is available, the expected overall percentage of male employees should be determined by using the factors in Table XXXVI.2 and the Standard Industrial Classification (“SIC”) code of the group. The percentage of female employees is then calculated by subtracting the percentage of male employees thus determined from 1.

Step 2: Using the male and female percentages determined in Step 1, blend the male and female non-smoker base rates from Table XXXVI.5 within each 5-year age bracket using the following formula:
Blended Non Smoker (“NS”) Base Rateᵢ=(% male)×(male NS base rate)ᵢ+(% female)×(female NS base rate)ᵢ for each age bracket i.

Step 3: Using the male and female percentages determined in Step 1, blend the male and female smoker base rates from Table XXXVI.5 within each 5-year age bracket using the following formula:
Blended Smoker (“S”) Base Rateᵢ=(% male)×(male S base rate)ᵢ+(% female)×(female S base rate)ᵢ for each age bracket i.

Step 4: Multiply each 5-year bracket rate in the non-smoker step rate table derived in Step 2 and each 5-year bracket rate in the smoker step rate table derived in step 3 by the applicable Industry Adjustment Factor from Table XXXVI.2.

Step 5: Multiply each 5-year bracket rate in the non-smoker step rate table derived in Step 4 and each 5-year bracket rate in the smoker step rate table derived in Step 4 by the appropriate Volume Adjustment Factor from Table XXXVI.7. Use the appropriate factor from Table XXXVI.7 based on the anticipated enrollment methodology to be employed in marketing coverage to the group.

If the group policyholder prefers an uni-smoker rate structure, a schedule of uni-smoker rates may be developed. Instead of blending non-smoker and smoker base rates in Steps 2 and 3, the uni-smoker base rates in Table XXXVI.5 can be used directly in Step 1 to derive the sex-blended base rates.

Step 6: Adjust the results from Step 5 to reflect an increasing trend in claim cost. The baseline rates derived from Step 5 will be multiplied by 1.xxxˆT, where T is the elapsed time (measured in years) from Jul. 1, 2005 to the mid-point of the prospective policy period.

Step 7: Broker commissions payable in accordance with Section XXX of this manual will be included in the final premium rates if applicable.

Step 8: Round the results from Step 7 to 2 decimal places to determine the final result.

C. Adjustments to Standard Monthly Premium Rates for Voluntary Insurance on Employees

1. If any of the Covered Conditions outlined in Section II.A are to be included with a different benefit percentage, the premium rate determined in Step 3 should be multiplied by a factor (f_{Bj}) for each age bracket j, before proceeding to Step 4, where f_{Bj} is defined as
   f_{Bj}=1−Σᵢ((1−Bᵢ)*Cⱼᵢ), i=1,6
   where
   j is the index for age bracket,
   Bᵢ is the ratio of the new benefit percentage to the standard benefit percentage for Covered Condition i, and
   Cⱼᵢ is the age- and sex-dependent weight of Covered Condition i, as outlined in Table XXXVI.4, Part C and D.
      D. Monthly Premium Rates for Standard Schedule of Voluntary Insurance on Dependent Spouses

The standard monthly premium rates per $1,000 of coverage for each group applicable to voluntary dependent spouse coverage will be computed based on the demographics of the group and the principal industry of employment of that group according to the following algorithm.

Step 1: Determine the expected distribution of coverage between male and female dependent spouses. If a group specific dependent spouse census is available, the percentage of male and female dependent spouses within the overall group should be determined directly from the data. If no dependent spouse census is available, the expected overall percentage of male dependent spouses should be determined by subtracting the percentage of female employees in the group from 1. The percentage of female dependent spouses is then calculated by subtracting the percentage of male dependent spouses thus determined from 1.

Step 2: Using the male and female percentages determined in Step 1, blend the male and female spouse non-smoker base rates from Table XXXVI.6 within each 5-year age bracket using the following formula:
Blended Non Smoker (“NS”) Base Rateᵢ=(% male)×(male NS base rate)ᵢ+(% female)×(female NS base rate)ᵢ for each age bracket i.

Step 3: Using the male and female percentages determined in Step 1, blend the male and female spouse smoker base rates from Table XXXVI.6 within each 5-year age bracket using the following formula:
Blended Smoker (“S”) Base Rateᵢ=(% male)×(male S base rate)ᵢ+(% female)×(female S base rate) for each age bracket i.

Step 4: Multiply each 5-year bracket rate in the non-smoker step rate table derived in Step 2 and each 5-year bracket rate in the smoker step rate table derived in step 3 by the applicable Industry Adjustment Factor from Table XXXVI.2.

Step 5: Multiply each 5-year bracket rate in the non-smoker step rate table derived in Step 4 and each 5-year bracket rate in the smoker step rate table derived in step 4 by the appropriate Volume Adjustment Factor from Table XXXVI.7. Use the appropriate factor from Table XXXVI.7 based on the anticipated enrollment methodology to be employed in marketing coverage to the group.

If the group policyholder prefers an uni-smoker rate structure, a schedule of uni-smoker rates may be developed. Instead of blending non-smoker and smoker base rates in Steps 2 and 3, the uni-smoker base rates from Table XXXVI.6 can be used directly in Step 1 to derive the sex-blended base rates.

Step 6: Adjust the results from Step 5 to reflect an increasing trend in claim cost. The baseline rates derived from Step 5 will be multiplied by 1.xxxˆT, where T is the elapsed time (measured in years) from Jul. 1, 2005 to the mid-point of the prospective policy period.

Step 7: Broker commissions payable in accordance with Section XXX of this manual will be included in the final premium rates if applicable.

Step 8: Round the results from Step 7 to 2 decimal places to determine the final results.

E. Adjustments to Standard Monthly Premium Rates for Voluntary Insurance on Dependent Spouses

1. If any of the Covered Conditions outlined in Section II.A are to be included with a different benefit percentage, the premium rate determined in Step 3 should be multiplied by a factor (f_{Bj}) for each age bracket j, before proceeding to Step 4, where f_{Bj} is defined as
   f_{Bj}=1−Σᵢ((1−Bᵢ)*Cⱼᵢ), i=1,6
   where
   j is the index for age bracket,
   Bᵢ is the ratio of the new benefit percentage to the standard benefit percentage for Covered Condition i, and
   Cⱼᵢ is the age- and sex-dependent weight of Covered Condition i, as outlined in Table XXXVI.4, Part C and D.
      F. Standard Monthly Premium Rates for Voluntary Insurance on Dependent Children

If the policy provides voluntary benefits for dependent children, the standard monthly premium rates per $1,000 will be based on the age at which dependent child coverage ends as contained in the policy as shown in Table XXXVI.8.

IV. The provisions of a particular employer's plan may call for variations in approved benefit designs not explicitly outlined. Appropriate interpolation or extrapolation methods will be used to determine premium rates for plans or benefits with specifications different from those shown in this section.

TABLE XXXVI.1A
Base Monthly Premium Rates per $1,000 for Non-Contributory Coverage

| | | | | | |
|---|---|---|---|---|---|
| Age | Male | Female | Age | Male | Female |

| | |
|---|---|
| 17 | |
| 18 | |
| . . . | 99 |
| | 100 |

TABLE XXXVI.1B
Skin Cancer Base Monthly Premium Rates per $1,000 for Non-
Contributory Coverage

| | | | | | |
|---|---|---|---|---|---|
| Age | Male | Female | Age | Male | Female |

| | |
|---|---|
| 17 | |
| 18 | |
| . . . | 99 |
| | 100 |

TABLE XXXVI.2
Industry Adjustment Factors

| | | Male | |
|---|---|---|---|
| SIC* | Industry Description | Percent | Factors |
| 100 | Agricultural Production, Crops | | |
| 200 | Agricultural Production, Livestock | | |
| 700 | Agricultural Services, N.E.C | | |
| 800 | Forestry | | |
| 900 | Fishing, Hunting, And Trapping | | |
| 1000 | Metal Mining | | |
| 1100 | Anthracite Mining | | |
| 1200 | Coal Mining | | |
| 1220 | Bituminous Coal | | |
| 1230 | Anthracite Mining | | |
| 1300 | Oil And Gas Extraction | | |
| 1400 | Nonmetallic Mining And Quarrying, Except Fuel | | |
| 1500 | General Building Contractors | | |
| 1600 | Heavy Construction Contractors | | |
| 1700 | Special Trade Contractors | | |
| 2000 | Food And Kindred Products | | |
| 2100 | Tobacco Manufacturers | | |
| 2200 | Textile Mill Products | | |
| 2300 | Apparel And Other Finished Textile Products | | |
| 2400 | Lumber And Wood Products, Except Furniture | | |
| 2500 | Furniture And Fixtures | | |
| 2600 | Paper And Allied Products | | |
| 2700 | Printing, Publishing, And Allied Products | | |
| 2710 | Newspaper Publishing And Printing | | |
| 2750 | Commercial Printing | | |
| 2800 | Chemicals And Allied Products | | |
| 2900 | Petroleum And Coal Products | | |
| 3000 | Rubber And Miscellaneous Plastics Products | | |
| 3100 | Leather And Leather Products | | |
| 3140 | Footwear, Except Rubber And Plastic | | |
| 3200 | Stone, Clay, Glass, And Concrete Products | | |
| 3290 | Miscellaneous Nonmetallic Mineral And Stone Products | | |
| 3300 | Primary Metal Industries | | |
| 3310 | Blast Furnaces, Steelworks, Rolling, And Finishing Mills | | |
| 3320 | Iron And Steel Foundries | | |
| 3400 | Fabricated Metal Industries | | |
| 3440 | Fabricated Structural Metal Products | | |
| 3500 | Machinery And Computing Equipment | | |
| 3530 | Construction And Material Handling Machines | | |
| 3540 | Metal Working Machinery | | |
| 3550 | Machinery And Computing Equipment | | |
| 3560 | General Industrial Machinery | | |
| 3570 | Computers And Related Equipment | | |
| 3580 | Service Industry Machines | | |
| 3600 | Electrical Machinery, Equipment, And Supplies | | |
| 3610 | Electrical Test and Distributing Equipment | | |
| 3620 | Electrical Industrial Apparatus | | |
| 3630 | Household Appliances | | |
| 3660 | Radio, T.V., And Communication Equipment | | |
| 3670 | Electrical Machinery, Equipment, And Supplies, N.E.C. And | | |
| | Not Specified | | |
| 3700 | Transportation Equipment | | |
| 3710 | Motor Vehicles And Motor Vehicle Equipment | | |
| 3720 | Aircraft And Parts | | |
| 3800 | Professional And Photographic Equipment, And Watches | | |
| 3900 | Miscellaneous And Not Specified Manufacturing Industries | | |
| 4000 | Railroads | | |
| 4100 | Bus Service And Urban Transit | | |
| 4200 | Trucking & Warehousing | | |
| 4210 | Trucking, Local & Long Distance | | |
| 4300 | U.S. Postal Service | | |
| 4400 | Water Transportation | | |
| 4500 | Air Transportation | | |
| 4600 | Gas And Steam Supply Systems | | |
| 4700 | Services Incidental To Transportation | | |
| 4800 | Communications | | |
| 4900 | Utilities And Sanitary Services | | |
| 4910 | Electric Light And Power | | |
| 4920 | Gas And Steam Supply Systems | | |
| 4930 | Electric and gas, and other combinations | | |
| 5000 | Durable Goods | | |
| 5100 | Non-Durable Goods | | |
| 5200 | Lumber And Building Material Retailing | | |
| 5300 | Miscellaneous General Merchandise Stores | | |
| 5310 | Department Stores | | |
| 5400 | Food Stores, N.E.C | | |
| 5410 | Grocery Stores | | |
| 5500 | Motor Vehicle Dealers | | |
| 5600 | Apparel And Accessory Stores, Except Shoe | | |
| 5700 | Furniture And Home Furnishings Stores | | |
| 5800 | Eating And Drinking Places | | |
| 5900 | Drug Stores | | |
| 6000 | Banking | | |
| 6010 | Federal Reserve Banks | | |
| 6020 | Commercial & Stock Savings Banks | | |
| 6100 | Credit Agencies, N.E.C | | |
| 6200 | Security, Commodity Brokerage, And Investment | | |
| | Companies | | |
| 6300 | Insurance Carriers | | |
| 6400 | Insurance Agents, Brokers, & Services | | |
| 6500 | Real Estate, Including Real Estate-Insurance Offices | | |
| 6600 | Combination Real Estate, Insurance, Etc. | | |
| 6700 | Holding And Other Investment Offices | | |
| 7000 | Hotels And Motels | | |
| 7200 | Personal Services, Except Private Household | | |
| 7300 | Business, Automobile, And Repair Services | | |
| 7370 | Computer And Data Processing Services | | |
| 7500 | Automotive Repair And Related Services | | |
| 7600 | Miscellaneous Repair Services | | |
| 7800 | Theaters And Motion Pictures | | |
| 7900 | Entertainment And Recreation Services | | |
| 8000 | Professional And Related Services | | |
| 8100 | Legal Services | | |
| 8200 | Educational Services | | |
| 8210 | Elementary And Secondary Schools | | |
| 8220 | Colleges And Universities | | |
| 8300 | Social Services, N.E.C | | |
| 8400 | Museums, Art Galleries, And Zoos | | |
| 8600 | Membership Organizations, N.E.C | | |
| 8610 | Business Associations | | |
| 8630 | Labor Unions | | |
| 8660 | Religious Organizations | | |
| 8700 | Engineering/Accounting/R & D | | |
| 8710 | Engineering & Architectural Services | | |
| 8720 | Accounting, Auditing, And Bookkeeping Services | | |
| 8730 | Research, Development, And Testing Services | | |
| 8800 | Private Households | | |
| 8900 | Miscellaneous Professional And Related Services | | |
| 8910 | Engineering & Architectural Services | | |
| 8920 | Non-Commercial Research | | |
| 8930 | Accounting And Auditing | | |
| 9100 | Executive And Legislative Offices | | |
| 9200 | Justice, Public Order, And Safety | | |
| 9300 | Public Finance, Taxation, And Monetary Policy | | |
| 9400 | Administration Of Human Resources Programs | | |
| 9500 | Administration Of Environmental Quality And Housing | | |
| | Programs | | |
| 9600 | Administration Of Economic Programs | | |
| 9700 | National Security And International Affairs | | |
| 9900 | Non-Classifiable Establishments | | |

*The appropriate NAICS Code may be used in lieu of the SIC Code

TABLE XXXVI.3
Non-Contributory Coverage Volume Adjustment Factors

| | Volume |
|---|---|
| Annual Specified Disease Premium | Adjustment Factor |
| LE $30,000 | |
| $30,001 to $50,000 | |
| $50,001 to $100,000 | |
| $100,001 to $250,000 | |
| $250,001 to $500,000 | |
| $500,001 to $1,000,000 | |
| $1,000,001 to $3,000,000 | |
| $3,000,001 to $5,000,000 | |
| $5,000,001 to $10,000,000 | |
| $10,000,001+ | |

Footnotes to Table XXXVI.3:
For the following additional expense items, the increase to premium would fall in the range of 0.xx% to xx.x% for each item:
Customized marketing material
Customized proposals
More complex administrative structure (due to multiple separations, etc.)
Customized quotation and underwriting tools
Customized legal and contractual arrangements
Customized billing and collections procedures
Special customer reporting
Special customer meetings
Special customer service requirements
Special printing requirements
Customized administration manuals
Special solicitation materials
Performance guarantees

The provider may enter into agreements with third parties under which the allowance, if any, paid to the third party for performing certain functions is less than the corresponding allowance implied by the factors above. The provider may reduce the premium up to xx.x % for each of the following performed by a third party:
Billing and collection
Preparation of quotes
Payment of claims
Payment of broker commissions
Marketing and promotion

Issuance of certificates

TABLE XXXVI.4
Premium Adjustment Factors for Covered Conditions Different from the
Standard Covered Conditions Outlined in Section II.A
A. Employer Paid, Employee Coverage

| | | | | | | Cⱼ₆ |
|---|---|---|---|---|---|---|
| | Cⱼ₁ | | Cⱼ₃ | | Cⱼ₅ | Coronary |
| | Kidney | Cⱼ₂ | Major Organ | Cⱼ₄ | Cancer (all | Artery |
| Age (j) | Failure | Heart Attack | Transplant | Stroke | benefit types) | Bypass Graft |
| <25 | | | | | | |
| 25-29 | | | | | | |
| 30-34 | | | | | | |
| . . . | | | | | | |
| 80-84 | | | | | | |
| 85+ | | | | | | |

B. Employer Paid, Dependent Spouse Coverage

| | | | | | | Cⱼ₆ |
|---|---|---|---|---|---|---|
| | Cⱼ₁ | | Cⱼ₃ | | Cⱼ₅ | Coronary |
| | Kidney | Cⱼ₂ | Major Organ | Cⱼ₄ | Cancer (all | Artery |
| Age (j) | Failure | Heart Attack | Transplant | Stroke | benefit types) | Bypass Graft |
| <25 | | | | | | |
| 25-29 | | | | | | |
| 30-34 | | | | | | |
| . . . | | | | | | |
| 80-84 | | | | | | |
| 85+ | | | | | | |

C. Voluntary Coverage, Male

| | | | | | | Cⱼ₆ |
|---|---|---|---|---|---|---|
| | Cⱼ₁ | | Cⱼ₃ | | Cⱼ₅ | Coronary |
| | Kidney | Cⱼ₂ | Major Organ | Cⱼ₄ | Cancer (all | Artery |
| Age (j) | Failure | Heart Attack | Transplant | Stroke | benefit types) | Bypass Graft |
| <25 | | | | | | |
| 25-29 | | | | | | |
| 30-34 | | | | | | |
| . . . | | | | | | |
| 80-84 | | | | | | |
| 85+ | | | | | | |

D. Voluntary Coverage, Female

| | | | | | | Cⱼ₆ |
|---|---|---|---|---|---|---|
| | Cⱼ₁ | | Cⱼ₃ | | Cⱼ₅ | Coronary |
| | Kidney | Cⱼ₂ | Major Organ | Cⱼ₄ | Cancer (all | Artery |
| Age (j) | Failure | Heart Attack | Transplant | Stroke | benefit types) | Bypass Graft |
| <25 | | | | | | |
| 25-29 | | | | | | |
| 30-34 | | | | | | |
| . . . | | | | | | |
| 80-84 | | | | | | |
| 85+ | | | | | | |

Note: j is the index denoting age bracket.

TABLE XXXVI.5
Voluntary Employee Monthly Base Premium Rates per $1,000

| | | | | | | |
|---|---|---|---|---|---|---|
| Employee | Male | Male | Male | Female | Female | Female |
| Age Bracket | Non-Smoker | Smoker | Uni-Smoker | Non-Smoker | Smokier | Uni-Smoker |

Less than 25
25 to 29
30 to 34
. . .
80 to 85
85+

TABLE XXXVI.6
Voluntary Dependent Spouse Monthly Base Premium Rates per S1,000

| | | | | | | |
|---|---|---|---|---|---|---|
| | Female | Female | Female | Male Spouse | Male Spouse | Male Spouse |
| | Spouse (Male | Spouse (Male | Spouse (Male | (Female | (Female | (Female |
| Employee | Employee) | Employee) | Employee) | Employee) | Employee) | Employee) |
| Age Bracket | Non-Smoker | Smoker | Uni-Smoker | Non-Smoker | Smoker | Uni-Smoker |

Less than 25
25 to 29
30 to 34
. . .
80 to 85
85+

TABLE XXXVI.7
Voluntary Coverage Volume Adjustment Factors

| | No Face-to-Face | With Face-to- |
|---|---|---|
| Annual Specified Disease | Enrollment | Face Enrollment |
| Premium | Methods | Methods |
| LE $30,000 | | |
| $30,001 to $50,000 | | |
| $50,001 to $100,000 | | |
| $100,001 to $250,000 | | |
| $250,001 to $500,000 | | |
| $500,001 to $1,000,000 | | |
| $1,000,001 to $3,000,000 | | |
| $3,000,001 to $5,000,000 | | |
| $5,000,001 to $10,000,000 | | |
| $10,000,001+ | | |

Footnotes to Table XXXVI.7:
1) For the following additional expense items, the increase to premium would fall in the range of xx.x% to xx.x% for each item:
a) Customized marketing material
b) Customized proposals
c) More complex administrative structure (due to multiple separations, etc.)
d) Customized quotation and underwriting tools
e) Customized legal and contractual arrangements
f) Customized billing and collections procedures
g) Special customer reporting
h) Special customer meetings
i) Special customer service requirements
j) Special printing requirements
k) Customized administration manuals
l) Special solicitation materials
m) Performance guarantees

2) The provider may enter into agreements with third parties under which the allowance, if any, paid to the third party for performing certain functions is less than the corresponding allowance implied by the factors above. The provider may reduce the premium up to x.x % for each of the following performed by a third party:
   a) Billing and collection
   b) Preparation of quotes
   c) Payment of claims
   d) Payment of broker commissions
   e) Marketing and promotion

f) Issuance of certificates

TABLE XXXVI.8
Voluntary Child Coverage Monthly Base
Premium Rates per $1,000

| Dependent Child Definition | Monthly Premium Rate per $1,000 |
|---|---|
| To age 18 | |
| To age 19* | |
| To age 20* | |
| To age 21* | |
| To age 22* | |
| To age 23* | |
| To age 24* | |
| To age 25* | |
| To age 26* | |

*provided the child is a full time student

| | | | |
|---|---|---|---|
| Covered | | Covered | |
| Person's Age | | Person's Age | |
| at end of | | at end of | |
| Calendar | Monthly Premiums/ | Calendar | Monthly Premiums/ |
| Year | $1,000 of Insurance | Year | $1,000 of Insurance |

Portable Rates for Former Employees and Dependent
Spouses of Former Employees Non-Smoker

| | |
|---|---|
| 17 | |
| 18 | . . . |
| . . . | 99 |
| | 100 |

Portable Rates for Former Employees and Dependent
Spouses of Former Employees Smoker

| | |
|---|---|
| 17 | |
| 18 | . . . |
| . . . | 99 |
| | 100 |

Portable Rates for Former Employees and Dependent
Spouses of Former Employees Uni-Smoker

| | |
|---|---|
| 17 | |
| 18 | . . . |
| . . . | 99 |
| | 100 |

Portable Certificate Administrative Expense Charge

To the monthly premium rates per thousand dollars of insurance specified on Pages 36.19-36.21, add the following administrative expense charge:

Up to $xx.xx per month per portable certificate

In one embodiment, product specifications are determined by reviewing a product template specification. Such a template is illustrated below.

Product Specifications Template for Critical Illness Policy

NATIONWIDE VERSION

| | | Individual Sold | |
|---|---|---|---|
| | | Through Group | |
| PLAN FEATURE | Individual | Channels | Group |
| Free Look Provision | [10 DAYS] | [10 days] | [None] |
| Issue Ages | [Principal Insured: | [Principal Insured: | [Employee: 16-65] |
| | 18-65] | 18-65] | |
| | [Spouse: 18-65] | [Spouse: 18-65] | [Spouse: 16-65] |
| | [Child: Birth to 18 | [Child: Birth to 18 | [Child: Birth to 18 |
| | (to 25 if full-time | (to 25 if full-time | (to 25 if full-time |
| | student)] | student)] | student)] |
| | | [We will need to | [We will need to |
| | | develop an ADEA | develop an ADEA |
| | | compliant way to limit | compliant way to limit |
| | | issue age] | issue age] |
| Domestic Partner | [Yes] | [Yes] | [Yes] |
| Coverage Available | | | |
| Eligibility | [Major medical | [Major medical | [Major medical |
| | necessary] | necessary] | necessary] |
| | | [Actively at work | [Actively at work |
| | | requirement] | requirement] |
| Premium Rates Based | [Issue Age] | [Issue Age] | [Attained Age] |
| On | [Gender] | [Unisex] | [Unisex] |
| | [Smoker status] | [Smoker status] | [Smoker status] |
| | [Once covered, | [Once covered, | Once covered, rates |
| | premium rate does not | premium rate does not | increase in 5 year age |
| | increase with age] | increase with age] | bands. |
| | | | Group experience |
| Premium Rate | [Charge for principal | [Charge for principal | [Employee only, rates |
| Structure | insured based on entry | insured based on entry | based on attained age |
| | age, additional charge | age, additional charge | (5 yr. bands); |
| | for spouse based on | for spouse based on | Employee and Spouse |
| | entry age, flat | entry age, flat | rates bases on attained |
| | additional charge for | additional charge for | age (5 yr. bands); |
| | dependent children - | dependent children - | Employee (with or |
| | $5,000 | $5,000 | without spouse) and |
| | | | children, flat charge to |
| | | | add children - $5,000. |
| | | | Flat rate for employer |
| | | | contributions. |
| Ability to Change | [Premiums may | [Premiums may | Premiums based on |
| Rates | only be changed | only be changed on | group, can be |
| | on a class basis] | a class basis] | changed annually, |
| | [Need definition of | [Need definition of | or if a significant |
| | class] Class is | class] Class is | change in size or |
| | defined as age, sex, | defined as age, sex, | composition of the |
| | smoker status, and | smoker status, and | group. |
| | policy form. | policy form. | Prospectively |
| | | | experience rated by |
| | | | group. |
| RATE GUARANTEE | Guaranteed renewable | Guarantee renewable | Yes, as specified by |
| | | | underwriting |
| PREMIUM | [Check-o-matic, direct | [Payroll deduction, | [Payroll deduction, |
| PAYMENT METHOD | bill, credit card | check-o-matic, direct | check-o-matic, direct |
| | | bill, credit card | bill, credit card |
| Frequency of Premium | [Annually, quarterly, | [Monthly, or according | [Monthly, or |
| Payment | monthly, semi-annually | to employer payroll | according to |
| | | frequency. | employer |
| | | | payroll |
| | | | frequency. |
| Renewability | [Guaranteed | [Guaranteed | Subject to annual |
| | Renewable (principal | Renewable (principal | mutual agreement of |
| | insured has the right to | insured has the right to | group policyholder and |
| | renew coverage for as | renew coverage for as | Provider. |
| | long as he/she lives and | long as he/she lives and | [Provider cannot |
| | either all or a portion of | either all or a portion of | change benefits except |
| | the principal insured's | the principal insured's | as required by law |
| | maximum benefit | maximum benefit | |
| | remains available] | remains available] | |
| | [Provider cannot | [Provider cannot | |
| | change benefits except | change benefits except | |
| | as required by law] | as required by law] | |
| | [Provider cannot | [Provider cannot | |
| | change premiums | change premiums | |
| | except on a class basis] | except on a class basis] | |
| Portability/Conversion | [Dependents have the | [Dependents have the | [Coverage may |
| | right to convert to their | right to convert to their | continue through a |
| | own policies without | own policies without | separate portability |
| | evidence of insurability | evidence of insurability | pool with distinct rates, |
| | if coverage for the | if coverage for the | and a portable charge |
| | dependent under the | dependent under the | (per $1,000) applied to |
| | principal insured's | principal insured's | the respective group |
| | policy terminates for | policy terminates for | program. |
| | reasons other than non- | reasons other than non- | Where required, |
| | payment of premium. | payment of premium. | conversion to an |
| | The amount of the | The amount of the | individual policy form |
| | converted policy | converted policy | at standard rates will be |
| | cannot exceed the | cannot exceed the | allowed. A conversion |
| | amount of coverage the | amount of coverage the | charge (per $1,000) |
| | dependent had in force | dependent had in force | will be applied to the |
| | at the time coverage | at the time coverage | respective group. |
| | under the original | under the original | |
| | policy ended.] | policy ended.] | |
| | [Premium is based on | [Premium is based on | |
| | issue age under the | issue age under the | |
| | original policy] | original policy] | |
| Critical Illnesses | [First occurrence of the | First occurrence of the | [First occurrence of the |
| Covered (see also | following: Invasive | following: Invasive | following: Invasive |
| definitions below) | Cancer, Cancer In Situ | Cancer, Cancer In Situ | Cancer, Cancer In Situ |
| | (25%), Heart Attack, | 25%), Heart Attack, | (25%), Heart Attack, |
| | Stroke, End Stage | Stroke, End Stage | Stroke, End Stage |
| | Renal Failure, Major | Renal Failure, Major | Renal Failure, Major |
| | Organ Transplant] | Organ Transplant] | Organ Transplant] |
| Invasive Cancer | [Cancer (Life- | [Cancer (Life- | [Cancer (Life- |
| | threatening) means the | threatening) means the | threatening) means the |
| | presence of one or | presence of one or | presence of one or |
| | more malignant | more malignant | more malignant |
| | tumors. A malignant | tumors. A malignant | tumors. A malignant |
| | tumor is to be | tumor is to be | tumor is to be |
| | characterized by the | characterized by the | characterized by the |
| | uncontrollable and | uncontrollable and | uncontrollable and |
| | abnormal growth and | abnormal growth and | abnormal growth and |
| | spread of malignant | spread of malignant | spread of malignant |
| | cells and the invasion | cells and the invasion | cells and the invasion |
| | and destruction of | and destruction of | and destruction of |
| | adjacent tissues for | adjacent tissues for | adjacent tissues for |
| | which major | which major | which major |
| | interventionist | interventionist | interventionist |
| | treatment or surgery | treatment or surgery | treatment or surgery |
| | (excluding endoscopic | (excluding endoscopic | (excluding endoscopic |
| | procedures alone) is | procedures alone) is | procedures alone) is |
| | considered medically | considered medically | considered medically |
| | necessary. Diagnosis | necessary. Diagnosis | necessary. Diagnosis |
| | must be based on | must be based on | must be based on |
| | microscopic | microscopic | microscopic |
| | examination | examination | examination |
| | (histologic | (histologic | (histologic |
| | examination) of fixed | examination) of fixed | examination) of fixed |
| | tissues or preparations | tissues or preparations | tissues or preparations |
| | of blood or bone | of blood or bone | of blood or bone |
| | marrow and | marrow and | marrow and |
| | documented in a | documented in a | documented in a |
| | written pathology | written pathology | written pathology |
| | report. This includes | report. This includes | report. This includes |
| | lymphomas, Hodgkin's | lymphomas, Hodgkin's | lymphomas, Hodgkin's |
| | disease and | disease and | disease and |
| | leukemia's.] | leukemia's.] | leukemia's.] |
| Cancer In Situ | [In-situ” cancers | [In-situ” cancers | [In-situ” cancers |
| | (carcinoma in-situ) | (carcinoma in-situ) | (carcinoma in-situ) |
| | which is a carcinoma | which is a carcinoma | which is a carcinoma |
| | characterized by | characterized by | characterized by |
| | malignant cellular | malignant cellular | malignant cellular |
| | growth of epithelial | growth of epithelial | growth of epithelial |
| | cells that have not | cells that have not | cells that have not |
| | invaded beyond the | invaded beyond the | invaded beyond the |
| | epithelial layer of | epithelial layer of | epithelial layer of |
| | tissue, classified as Tis | tissue, classified as Tis | tissue, classified as Tis |
| | N0M0. Such | N0M0. Such | N0M0. Such |
| | conditions are not | conditions are not | conditions are not |
| | considered life | considered life | considered life |
| | threatening but will be | threatening but will be | threatening but will be |
| | covered at 25% of face | covered at 25% of face | covered at 25% of face |
| | amount for the purpose | amount for the purpose | amount for the purpose |
| | of critical illness | of critical illness | of critical illness |
| | coverage.] | coverage. | coverage.] |
| | Skin cancers are not | Skin cancers are not | Skin cancers are not |
| | covered. | covered. | covered. |
| Heart Attack | [The death of a portion | [The death of a portion | [The death of a portion |
| | of the heart muscle as a | of the heart muscle as a | of the heart muscle as a |
| | result of obstruction of | result of obstruction of | result of obstruction of |
| | one or more of the | one or more of the | one or more of the |
| | coronary arteries due | coronary arteries due | coronary arteries due |
| | to atherosclerosis, | to atherosclerosis, | to atherosclerosis, |
| | spasm, thrombus or | spasm, thrombus or | spasm, thrombus or |
| | emboli. | emboli. | emboli. |
| | A positive diagnosis | A positive diagnosis | A positive diagnosis |
| | must be supported by | must be supported by | must be supported by |
| | three of the four | three of the four | three of the four |
| | following criteria: | following criteria: | following criteria: |
| | typical chest pain, | typical chest pain, | typical chest pain, |
| | electrocardiograph | electrocardiograph | electrocardiograph |
| | changes indicative of a | changes indicative of a | changes indicative of a |
| | recent myocardial | recent myocardial | recent myocardial |
| | infarction, | infarction, | infarction, |
| | elevation of CPK of | elevation of CPK of | elevation of CPK of |
| | myocardial origin, or | myocardial origin, or | myocardial origin, or |
| | elevated serum | elevated serum | elevated serum |
| | troponin levels, | troponin levels, | troponin levels, |
| | confirmatory imaging | confirmatory imaging | confirmatory imaging |
| | studies such as | studies such as | studies such as |
| | thallium scan or stress | thallium scan or stress | thallium scan or stress |
| | echocardiogram] | echocardiogram] | echocardiogram |
| Stroke | [Cerebro-vascular | [Cerebro-vascular | [Cerebro-vascular |
| | accident or incident | accident or incident | accident or incident |
| | producing permanent | producing permanent | producing permanent |
| | neurological sequelae | neurological sequelae | neurological sequelae |
| | caused by hemorrhage, | caused by hemorrhage, | caused by hemorrhage, |
| | infarction of brain | infarction of brain | infarction of brain |
| | tissue or an embolus | tissue or an embolus | tissue or an embolus |
| | from an extracranial | from an extracranial | from an extracranial |
| | source. Evidence of | source. Evidence of | source. Evidence of |
| | permanent | permanent | permanent |
| | neurological damage | neurological damage | neurological damage |
| | must be produced. | must be produced. | must be produced. |
| | Prolonged reversible | Prolonged reversible | Prolonged reversible |
| | ischemic neurological | ischemic neurological | ischemic neurological |
| | disease and transient | disease and transient | disease and transient |
| | ischemic attacks are | ischemic attacks are | ischemic attacks are |
| | not covered. The | not covered. The | not covered. The |
| | permanent nature of a | permanent nature of a | permanent nature of a |
| | neurological defect has | neurological defect has | neurological defect has |
| | to be confirmed by a | to be confirmed by a | to be confirmed by a |
| | neurologist at the | neurologist at the | neurologist at the |
| | earliest one (1) month | earliest one (1) month | earliest one (1) month |
| | after the event and no | after the event and no | after the event and no |
| | claims can be admitted | claims can be admitted | claims can be admitted |
| | earlier.] | earlier.] | earlier.] |
| Organ Transplant | [The actual | [The actual | [The actual |
| | undergoing, as a | undergoing, as a | undergoing, as a |
| | recipient, of the | recipient, of the | recipient, of the |
| | transplantation of the | transplantation of the | transplantation of the |
| | heart, lung, liver, | heart, lung, liver, | heart, lung, liver, |
| | kidney, pancreas or | kidney, pancreas or | kidney, pancreas or |
| | bone marrow (TBD), | bone marrow (TBD)or, | bone marrow (TBD), |
| | or any combination | any combination | or any combination |
| | there of.. | thereof. | thereof. |
| | Transplantation means | Transplantation means | Transplantation means |
| | the replacement of the | the replacement of the | the replacement of the |
| | recipient's | recipient's | recipient's |
| | malfunctioning | malfunctioning | malfunctioning |
| | organ(s) or tissue, with | organ(s) or tissue, with | organ(s) or tissue, with |
| | the organ(s) or tissue | the organ(s) or tissue | the organ(s) or tissue |
| | from a donor suitable | from a donor suitable | from a donor suitable |
| | under generally | under generally | under generally |
| | accepted medical | accepted medical | accepted medical |
| | procedures. We will | procedures. We will | procedures. We will |
| | not pay a benefit for | not pay a benefit for | not pay a benefit for |
| | organs received from | organs received from | organs received from |
| | non-human donors.] | non-human donors.] | non-human donors.] |
| Kidney Failure | [Confirmed diagnosis | [Confirmed diagnosis | [Confirmed diagnosis |
| | of Renal Kidney | of Renal Kidney | of Renal Kidney |
| | Failure, which is | Failure, which is | Failure, which is |
| | defined as the end | defined as the end | defined as the end |
| | stage of chronic | stage of chronic | stage of chronic |
| | irreversible failure of | irreversible failure of | irreversible failure of |
| | both kidneys to | both kidneys to | both kidneys to |
| | function, resulting in | function, resulting in | function, resulting in |
| | regular renal dialysis | regular renal dialysis | regular renal dialysis |
| | expected to continue | expected to continue | expected to continue |
| | for at least 6 months, or | for at least 6 months, or | for at least 6 months, or |
| | resulting in renal | resulting in renal | resulting in renal |
| | transplantation.] | transplantation.] | transplantation.] |
| Available Maximum | [$10,000 to $50,000, in | [$10,000 to $50,000, in | Standard Offering |
| Benefit Amounts | $10,000 increments] | $10,000 increments | [$10,000 to $50,000, in |
| | | | $5,000 increments.] |
| | | | Desired Variation - |
| | | | $5,000-$1 M. |
| Qualifying Events for | [Marriage] | [Marriage] | [Marriage] |
| Adding Coverage | [Birth or adoption of | [Birth or adoption of | [Birth or adoption of |
| | child(ren)] | child(ren)] | child(ren)] |
| Dependent Benefit | [Spouse not to exceed | [Spouse not to exceed | [Spouse not to exceed |
| Amounts | principal insured's | principal insured’s | employee/retiree |
| | amount. | amount] | amount. |
| | Child(ren) at $5,000 | Child(ren) at % 5,000 | Child(ren) at $5,000 |
| Percentage of | [Cancer In Situ pays | [Cancer In Situ pays | Standard Offering |
| Maximum Benefit | 25%; all other | 25%; all other | [Cancer In Situ pays |
| Amount Payable for | conditions are paid at | conditions are paid at | 25%; all other |
| Covered Conditions | 100%] | 100%] | conditions are paid at |
| | | | 100%] |
| | | | Desired variability - |
| | | | change %'s by |
| | | | coverage (0-100%). |
| Benefit Reductions | [Benefit for | [May also contain an | [May also contain an |
| Due to Age | principal insured | ADEA compliant | ADEA compliant |
| | reduced by 50% at | reduction formula] | reduction formula] |
| | age 65] | [Spouse benefit | [Spouse benefit |
| | [Spouse benefit | subject to 50% | subject to 50% |
| | subject to identical | reduction at age 65. | reduction at age |
| | reduction provision | [Subject to | 65. [Subject to |
| | based on age of | minimum 5-year | minimum 5-year |
| | spouse] | full benefit | full benefit |
| | [Subject to | beginning at age | beginning at age |
| | minimum 5-year | 65] | 65] |
| | full benefit | [We will need to | |
| | beginning at age | develop an ADEA | |
| | 65] | compliant | |
| | | reduction formula] | |
| Age at Which | Lifetime | Lifetime | Lifetime |
| Coverage Ends | | | |
| Waiting Period | [90 days for Invasive | [90 days for Invasive | [90 days for Invasive |
| | Cancer and Cancer In | Cancer and Cancer In | Cancer and Cancer In |
| | Situ; 30 days for all | Situ; 30 days for all | Situ; 30 days for all |
| | other covered | covered conditions] | covered conditions] |
| | conditions] | | |
| Preexisting Condition | [12/12, includes prudent | [12/12, includes prudent | [12/12, includes |
| | person language] | person language] | prudent person |
| | | | language] |
| Benefit Payment | [Lump sum | [Lump sum | [Lump sum |
| Increment | | | |
| Exhaustion of Benefits | [Payment of a partial | [Payment of a partial | [Payment of a |
| | Maximum Benefit | Maximum Benefit | partial Maximum |
| | Amount (for cancer in | Amount (for cancer in | Benefit Amount |
| | situ) reduces the | situ) reduces the | (for cancer in |
| | remaining benefit amount | remaining benefit amount | situ) reduces the |
| | and premiums charged | and premiums charged | remaining benefit |
| | therefore for the insured | therefore for the insured | amount and |
| | person; payment of the | person; payment of the | premiums |
| | full Maximum Benefit | full Maximum Benefit | charged therefore |
| | Amount terminates | Amount terminates | for the insured |
| | coverage for the person | coverage for the person | person; payment |
| | for whom the Maximum | for whom the Maximum | of the full |
| | Benefit Amount was paid. | Benefit Amount was paid. | Maximum Benefit |
| | If this is the principal | If this is the principal | Amount |
| | insured, the policy | insured, the policy | terminates |
| | terminates and dependents | terminates and dependents | coverage for the |
| | will have a right to | will have a right to | person for whom |
| | convert any remaining | convert any remaining | the Maximum |
| | amount to individual | amount to individual | Benefit Amount |
| | policies.] | policies.] | was paid. If this |
| | | | is the employee, |
| | | | the coverage for |
| | | | dependents is not |
| | | | affected.] |
| Duplicate Benefit | [Benefits payable | [Benefits payable | [Benefits |
| Payments | despite receipt of | despite receipt of | payable |
| | benefits for same | benefits for same | despite receipt |
| | illness under separate | illness under separate | of benefits for |
| | insurance coverage] | insurance coverage] | same illness |
| | | | under separate |
| | | | insurance |
| | | | coverage] |
| Diagnosis | Diagnosis means the | Diagnosis means the | Diagnosis means the |
| | definitive | definitive | definitive |
| | establishment of the | establishment of the | establishment of the |
| | Critical Illness | Critical Illness | Critical Illness |
| | condition through the | condition through the | condition through the |
| | use of clinical and/or | use of clinical and/or | use of clinical and/or |
| | laboratory findings. | laboratory findings. | laboratory findings. |
| | The diagnosis must be | The diagnosis must be | The diagnosis must be |
| | made by a Physician | made by a Physician | made by a Physician |
| | who is also a board- | who is also a board- | who is also a board- |
| | certified specialist. | certified specialist. | certified specialist. |
| | Date of Diagnosis is: | Date of Diagnosis is | Date of Diagnosis is |
| | the date the diagnosis | the date the diagnosis | the date the diagnosis |
| | is established by the | is established by the | is established by the |
| | physician. For major | physician. For major | physician. For major |
| | organ transplant, it is | organ transplant, it is | organ transplant, it is |
| | the date the procedure | the date the procedure | the date the procedure |
| | was performed | was performed | was performed |
| | [Diagnosis must be | [Diagnosis must be | [Diagnosis must be |
| | made by a Physician, | made by a | made by a |
| | other than the primary | Physician, other | Physician, other |
| | Insured or the owner, a | than the primary | than the primary |
| | member of the Primary | Insured or the | Insured or the |
| | Insured's or Owner's | owner, a member | owner, a member |
| | immediate family, or a | of the Primary | of the Primary |
| | business associate who | Insured's or | Insured's or |
| | is duly licensed in the | Owner's immediate | Owner's immediate |
| | United Sates and acting | family, or a | family, or a |
| | within the scope of his | business associate | business associate |
| | or her license and is not | who is duly | who is duly |
| | a member of your | licensed in the | licensed in the |
| | immediate family. | United States and | United States and |
| | Immediate family is | acting within the | acting within the |
| | defined as your or this | scope of his or her | scope of his or her |
| | policy owner's spouse, | license and is not a | license. Immediate |
| | son, daughter, father, | member of your | family is defined as |
| | mother, sister or | immediate family. | your or this policy |
| | brother | Immediate family | owner's spouse, |
| | [What type of | is defined as your | son, daughter, |
| | diagnosis is | or this policy | fater, mother |
| | required | owner's spouse, | sister or brother |
| | (pathological or | son, daughter, | |
| | clinical)] | father, mother, | |
| | | sister or brother | |
| Return of Premiums | [If the principal | [If the principal | |
| | insured dies from | insured dies from | |
| | causes other than a | causes other than a | |
| | covered critical | covered critical | |
| | illness, all | illness, all | |
| | premiums paid | premiums paid | |
| | under the policy | under the policy | |
| | with respect to the | with respect to the | |
| | principal insured | principal insured | |
| | are returned minus | are returned minus | |
| | any amounts paid in | any amounts paid in | |
| | claims with respect | claims with respect | |
| | to the principal | to the principal | |
| | insured.] | insured.] | |
| | [Premiums are paid | [Premiums are paid | |
| | to beneficiary | to beneficiary | |
| Claims During the | [If the principal insured | [If the principal insured | [If the principal insured |
| Waiting Period | is first diagnosed with a | is first diagnosed with a | is first diagnosed with a |
| | covered critical illness | covered critical illness | covered critical illness |
| | during the waiting | during the waiting | during the waiting |
| | period, coverage is | period, coverage is | period, coverage is |
| | rescinded and all | rescinded and all | rescinded and all |
| | premiums are returned. | premiums are returned. | premiums are returned. |
| | If a dependent is first | If a dependent is first | If a dependent is first |
| | diagnosed with a | diagnosed with a | diagnosed with a |
| | covered critical illness | covered critical illness | covered critical illness |
| | during the waiting | during the waiting | during the waiting |
| | period, coverage for | period, coverage for | period, coverage for |
| | that dependent is | that dependent is | that dependent is |
| | rescinded and | rescinded and | rescinded and |
| | premiums for that | premiums for that | premiums for that |
| | dependent are returned | dependent are returned | dependent are returned |
| | to the principal | to the principal | to the principal |
| | insured.] | insured.] | insured.] |
| Exclusions (in addition | [Participation in a | [Participation in a | [Participation in a |
| to Pre-Existing | felony, riot or | felony, riot or | felony, riot or |
| Conditions) | insurrection] | insurrection] | insurrection] |
| | [Intentionally | [Intentionally | [Intentionally |
| | causing a self- | causing a self- | causing a self |
| | inflicted injury] | inflicted injury] | inflicted injury] |
| | [Committing or | [Committing or | [Committing or |
| | attempting to | attempting to | attempting to |
| | commit suicide] | commit suicide] | commit suicide] |
| | [Involvement in any | [Involvement in any | [Involvement in any |
| | period of war or any | period of war or any | period of war or any |
| | act of war, even if | act of war, even if | act of war, even if |
| | war is not declared] | war is not declared] | war is not declared] |
| | [Loss resulting from | [Loss resulting from | [Loss resulting from |
| | insured person | insured person | insured person |
| | being intoxicated] | being intoxicated] | being intoxicated] |
| | [Loss resulting from | [Loss resulting from | [Loss resulting from |
| | insured person | insured person | insured person |
| | being under the | being under the | being under the |
| | influence of any | influence of any | influence of any |
| | controlled | controlled | controlled |
| | substance] | substance] | substance] |
| | [Loss sustained | [Loss sustained | [Loss sustained |
| | while engaging in | while engaging in | while engaging in |
| | an illegal | an illegal | an illegal |
| | occupation] | occupation] | occupation] |
| | [Loss sustained | [Loss sustained | [Loss sustained |
| | while serving in the | while serving in the | while serving in the |
| | armed forces or | armed forces or | armed forces or |
| | auxiliary units] | auxiliary units] | auxiliary units] |
| | [Do exclusions | [Do exclusions | [Do exclusions |
| | apply to return of | apply to return of | apply to return of |
| | premium provision] | premium provision] | premium provision] |
| | Yes, to be | Yes, to be consistent | Yes, to be |
| | consistent | | consistent |
| Claim Provisions | Written notice of a | Written notice of a | Written notice of a |
| | claim must be given | claim must be given | claim must be given |
| | to us within 30 days | to us within 30 days | to us within 30 days |
| | after loss occurs or | after loss occurs or | after loss occurs or |
| | starts, or as soon as | starts, or as soon as | starts, or as soon as |
| | reasonably possible. | reasonably possible | reasonably possible |
| | | | [Claim provisions |
| | | | in certificate only] |
| | Written proof of | Written proof of | Written proof of |
| | loss must be | loss must be | loss must be |
| | submitted within 90 | submitted within 90 | submitted within 90 |
| | days after the date | days after the date | days after the date |
| | of such loss. | of such loss. | of such loss. |
| | [Claim | [Claim | [Claim |
| | Investigation: | Investigation: | Investigation: |
| | Authorization to | Authorization to | Authorization to |
| | obtain medical | obtain medical | obtain medical |
| | records and medical | records and medical | records and medical |
| | examinations] | examinations] | examinations] |
| | [Time of Payment | [Time of Payment | [Time of Payment |
| | of Claim] | of Claim] | of Claim] |
| | May be changed | [Beneficiary] | [Beneficiary] |
| | during Primary | May be changed | May be changed |
| | Insurd's lifetime, | during Primary | during Primary |
| | and does not require | Insurd's lifetime, | Insurd's lifetime, |
| | consent of | and does not require | and does not require |
| | Beneficiaryy] | consent of | consent of |
| | [Change of | Beneficiary [ | Beneficiary |
| | Beneficiary] | | |
| Reinstatement | [Permitted with full | [PERMITTED WITH | [PERMITTED FOR |
| | underwriting] | FULL | ENTIRE GROUP AT |
| | | UNDER WRITING] | PROVIDER'S |
| | | | DISCRETION] |
| Waiver for Disability | [Yes] | [Yes] | [Yes] |
| Contestability | [Incontestable after two | [Incontestable after two | [Incontestable after two |
| | years except in case of | years except in case of | years except in case of |
| | fraud] | fraud] | fraud] |
| Survival Period (TBD) | 28-31 days (TBD). | 28-31 days (TBD). | 28-31 days (TBD). |
| | 10-20%(TBD) of face | 10-20%(TBD) of face | 10-20%(TBD) of face |
| | amount if death during | amount if death during | amount if death during |
| | survival period. | survival period. | survival period. |
| Settlement Options | Standard - TCA, | Standard - TCA, | Standard - TCA, Check |
| | Check optional | Check optional | optional |

An exemplary certificate of insurance is included as Appendix A.

### Actuarial Memorandum

### Group Specified Disease Coverage

1. Scope and Purpose

This is an initial filing of Group Policy Form xxxxx and Group Certificate Form xxxxx. These forms are new and do not replace any forms previously filed with your Department.

2. Description of Benefits

The Company will pay a lump-sum benefit amount, subject to the terms and conditions of the Group Policy, if a Covered Condition First Occurs while a Covered Person is insured under the Group Policy.

The Covered Conditions available under the Group Policy are:

| COVERED CONDITION | STANDARD OFFERING BENEFIT |
|---|---|
| Full Benefit Cancer | 100% of Total Benefit Amount |
| Partial Benefit Cancer | Lesser of {$15,000, |
| | 25% of Total Benefit Amount} |
| Skin Cancer | $250 |
| Other Cancer | $1,000 |
| Heart Attack | 100% of Total Benefit Amount |
| Coronary Artery Bypass Graft | Lesser of {$15,000, |
| | 25% of Total Benefit Amount} |
| Kidney Failure | 100% of Total Benefit Amount |
| Major Organ Transplant | 100% of Total Benefit Amount |
| Stroke | 100% of Total Benefit Amount |

The Covered Conditions included in a particular group policy, the percentage of the Total Benefit Amount payable for each Covered Condition, and the inside maximum amount payable for Partial Benefit Cancer and Coronary Artery Bypass Graft may vary to reflect the requirements of a particular employer's plan. If any form of cancer is included in the policy as a Covered Condition however, all forms included in the table will be provided.
Total Benefit Amounts will be offered for sale in even increments of $1,000. In no event shall coverage on any single individual exceed $500,000. For certain clearly identifiable forms of diseases with significantly lower expected treatment costs (e.g. basal cell and squamous cell skin cancers), lesser amounts may be offered, but in no event shall any such amount be lower than $250. The benefit for any Covered Condition will be paid in a single lump-sum.
Coverage is subject to a thirty (30) day Waiting Period (probationary period) for all Covered Conditions. In addition, the Group Certificate contains a six (6) month pre-existing condition exclusion.
Coverage may be offered on a non-contributory basis with premiums paid by the group policyholder or on a contributory basis with premiums paid by group certificate holders. Coverage may also be provided for dependent spouses and dependent children of employees.
3. Proposed Effective Date
This form is intended to be used as soon as approval has been obtained.
4. Morbidity
Expected claim costs for the benefits provided under the group policy were derived primarily from population data. Adjustments to the available population data were made as necessary to reflect the policy terms. The data sources used as the basis for developing expected claim costs for each of the Covered Conditions are as follows:

Cancer (all benefit types)_{—}
SEER Cancer Statistics Review
Incidence of Non-Melanoma Skin Cancer in the United States.

Heart Attack
Heart Disease & Stroke Statistics—2004 Update
ARIC Surveillance Study.
The Framingham Heart Study.

Stroke
Incidence and Occurrence of Total (First-Ever and Recurrent) Stroke.
Incidence and Characteristics of Total Stroke in the United States

Coronary Artery Bypass Graft
National Hospital Discharge Survey: 2000

Major Organ Transplant
2002 Annual Report, U.S. Organ Procurement and Transplantation Network.

Kidney Failure
U.S. Renal Data System Report, 2003.

Smoking Status
Health, United States
   5. Expense Assumptions

As this is a new form filing, expense assumptions are based on expected company experience. The expense assumptions include provisions for administration, underwriting, claims, marketing, general overhead, taxes, and commissions. Based on the expected distribution of business, the average expenses included in this set of manual rates are:

| | |
|---|---|
| Administration, claims, marketing, underwriting, | xx.x% of premium |
| and general overhead: | |
| Taxes, Licenses, & Fees: | xx.x% of premium |
| Standard Commissions: | xx.x% of premium |
| Total Expenses: | xx.x% of premium |

6. Margin
The premium rates in this filing were developed with xx % of annual claims margin.
7. Expected Loss Ratio
Based on the assumptions contained herein, the incurred loss ratio under this set of manual rates is expected to be:
X %
   8. Valuation

Claim Liabilities

A. Pending claims: The underwriter will hold a percentage of the benefit amount of all claims pending on the valuation date.

B. Claims Incurred but Not Reported: For claims that have been incurred but not reported to the Company (IBNR), the underwriter will hold an incurred but not reported claim liability as a function of claims, using factors developed from claim lag studies. From time to time, the underwriter will update its IBNR factors according to the results of ongoing claim lag studies.

C. Active Life Reserves: Group Specified Disease coverage is annual term insurance. No active life reserves are necessary for the group policy.

9. Actuarial Certification

To the best of my knowledge and judgement:

the expected loss ratio under this set of rates meets the minimum requirements of the State of New York; and
the rates are structured on an actuarially sound basis; and
the benefits are reasonable in relation to the premiums charged.

As will be recognized by those skilled in the art, various aspects illustrated above can be implemented on a various computer systems. For example, in one embodiment, a computer system can be implemented providing a database for storing information about the insurance provider, the group policyholder, or the insured member. Further, the computer system may be further operable to calculate the described premiums. Further, the computer system may provide an interface for various parties to the policy to track, edit, or view policy related data.

While the present invention has been illustrated and described above regarding various embodiments, it is not intended to be limited to the details shown, since various modifications and structural changes may be made without departing from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A computer implemented method for providing insurance comprising:
issuing a group term specified disease insurance policy covering one or more conditions;
receiving a premium payment based at least in part on said one or more conditions; and
in response to data indicating that said one or more policy terms are met, paying a claim amount based at least in part on said one or more conditions.

2. The method of claim 1 further comprising the step of electronically calculating premiums based at least in part on said one or more conditions.

3. The method of claim 1 wherein said one or more conditions comprises at lease one of: 1) full benefit cancer, 2) partial benefit cancer, 3) heart attack, 4) coronary artery bypass graft, 5) kidney failure, 6) major organ transplant, 7) stroke, 8) skin cancer, and 9) other cancer.

4. A system of insurance policy maintenance comprising:
a database component operable to store information related to one or more group term specified disease insurance policies, said group specified disease insurance policy comprising information related to one or more conditions;
an insurance maintenance component operable to update said database with information related to said one or more group term disease insurance policies; and
a payment component operable to send a notification that a claim amount should be paid, said notification sent in response to data indicating that said one or more policy terms have been met.

5. The system of claim 4 further comprising a premium calculation component, said premium based at least in part on said one or more conditions.

6. The system of claim 4 wherein said one or more conditions comprises at least one of: 1) full benefit cancer, 2) partial benefit cancer, 3) heart attack, 4) coronary artery bypass graft, 5) kidney failure, 6) major organ transplant, 7) stroke, 8) skin cancer, and 9) other cancer.
